(19) United States
(12) Patent Application Publication
(10) Pub. No.: US 2008/0221866 A1
(43) Pub. Date: Sep. 11, 2008

(54) Machine Learning For Transliteration

(76) Inventors: Lalitesh Katragadda, Bangalore (IN); Pawan Deshpande, Andover, MA (US); Anupama Dutta, Ganganagar (IN); Nitin Arora, Bagh Delhi (IN)

Correspondence Address: FISH & RICHARDSON P.C., PO BOX 1022, MINNEAPOLIS, MN, 55440-1022, US

(21) Appl. No.: 12/043,854

(22) Filed: Mar. 6, 2008

Related U.S. Application Data
(60) Provisional application No. 60/893,370, filed on Mar. 6, 2007.

(51) Int. Cl. G06F 17/28

(52) U.S. Cl. 704/8

(57) ABSTRACT

Methods, systems, and apparatus, including computer program products, for performing transliteration between text in different scripts. In one aspect, a method includes generating a transliteration model based on statistical information derived from parallel text having first text in an input script and corresponding second text in an output script; and using the transliteration model to transliterate input characters in the input script to output characters in the output script. In another aspect, a method includes performing word level transliterations. In another aspect, a method includes using an entry-aligned dictionary of source and target script pairs, in which, whenever a particular source word is mapped to multiple target words, the dictionary includes an entry for each target word including the same source word repeated in each entry. In another aspect, a method includes using phonetic scores of words in different scripts to identify corresponding parallel text.

### CROSS REFERENCE TO RELATED APPLICATIONS

This application claims benefit under 35 U.S.C. § 119(e) of U.S. Patent Application No. 60/893,370, filed Mar. 6, 2007, which is incorporated herein by reference.

### BACKGROUND

This invention relates to automatic transliteration of words from one writing system to another writing system.

Electronic documents are typically written in many different languages. Each language is normally expressed in a particular writing system (i.e., a script), which is usually characterized by a particular alphabet. For example, the English language is expressed using the Latin alphabet while the Hindi language is normally expressed using the Devanāgarī alphabet. The scripts used by some languages include a particular alphabet that has been extended to include additional marks or characters. For example, the French language is written using a script that includes the basic Latin alphabet (i.e., the 26 unaccented characters from A to Z, upper and lower case) and also includes diacritics (i.e., accented characters) and ligatures (e.g., [symbol] ).

Unfortunately, the ability and ease of producing characters of any particular alphabet varies greatly from one input device to another. For example, many input devices, such as keyboards or mobile devices, are configured to generate characters of the basic Latin alphabet. These input devices are quite frequently used by users who want to produce characters and words in non-Latin based scripts (e.g., Indic, Russian, Hebrew, Chinese or Japanese).

A user may not be able to use these input devices to conveniently produce the letters of the script that they prefer. Instead, the user will often use the input device to provide a character or character sequence that is a close substitute. For example, a user may provide AE in lieu of [symbol] . These substitutions are a form of transliteration, whereby the script of one language (e.g., Latin alphabet) is used to express the script of another language (e.g., the French alphabet). The system receiving the substitute characters is often expected to transliterate the given characters into characters of the desired script. The rules and conventions of transliteration between scripts can vary even among the same two languages, often by geographic region and even from user to user. For example, in some regions of India the Hindi word “ [symbol] ” is expressed in the Latin alphabet as “Sharda”, whereas in other regions the same Hindi word is expressed as “Sharada”.

The conventional approach for transliteration is to use rules, which specify that one or two particular characters in one script can be mapped to one or two particular characters in another script. These rules are typically provided by a language expert. This approach depends heavily on the expertise of the language expert or on cultural conventions.

In some regions of the world no standardized transliteration rule systems exist, and even if they do exist can be difficult to use. For example, to phonetically spell an Indic language word in Latin script, some transliteration systems use mixed-case Latin text to write a word unambiguously. Such systems are not intuitive to the user.

### SUMMARY

This specification discloses various embodiments of technologies for machine-assisted transliteration. Embodiments feature methods, systems, apparatus, including computer program product apparatus. Each of these will be described in this summary be reference to the methods, for which there are corresponding systems and apparatus.

In general, one aspect of the subject matter described in this specification can be embodied in a method that includes receiving from a user an input of a sequence of multiple input characters entered in an input script. The sequence is terminated by entry of a word-break character where the word-break character is not part of the sequence. A transliteration model is used, after entry of the word-break character, to determine an output word in an output script from the sequence of multiple input characters. Other embodiments of this aspect include corresponding systems, apparatus, and computer program products.

These and other embodiments can optionally include one or more of the following features. The transliteration model can include a plurality of segments, each segment mapping one or more characters of the input script to one or more characters of the output script. Each segment in the plurality of segments can correspond to a word pair in a corpus of word pairs, where each segment can have a score based on a frequency of occurrence of the word pair in the corpus of word pairs. Using the transliteration model can include generating potential transliterations from the segments, each potential transliteration being derived from a combination of one or more segments; and selecting the transliteration to use to determine the output word based on the scores of the segments in each of the potential transliterations. Potential transliterations that exhibit letter and segment patterns that are statistically unlikely in reference to statistics collected from the corpus of word pairs can be pruned. The transliteration model can include a dictionary having entries in the input script and, for each entry, a corresponding word in the output script. The word-break character can be a space character or an end-of-sentence character. The sequence of multiple input characters in a user interface can be replaced with the output word in the output script. User input generated from an input device configured to generate characters in the input script is received.

In general, another aspect of the subject matter described in this specification can be embodied in a method that includes deriving multiple word pairs from multiple electronic documents that contain parallel text. The parallel text including text in a first script corresponding to text in a different, second script. A similarity score between the words in each word pair is determined based on a phonetic metric value of each word in the word pair. Word pairs are used that have a similarity score satisfying a threshold criterion for automatic transliteration. Other embodiments of this aspect include corresponding systems, apparatus, and computer program products.

These and other embodiments can optionally include one or more of the following features. Each phonetic metric value can be a soundex value. Deriving word pairs from multiple electronic documents can include aligning text within each document to identify text that is parallel; and deriving word pairs based on word alignments between parallel text. Deriving word pairs from multiple electronic documents can include using phonetic metric scoring and matching to align corresponding word pairs in unstructured text. The phonetic metric scoring can be a soundex scoring.

In general, another aspect of the subject matter described in this specification can be embodied in a method that includes receiving a corpus of word pairs. Each word pair in the corpus includes a source word and a target word. Each source word is specified in a source script and each target word is a transliteration of the corresponding source word in a different, target script. Relevant word pairs from the corpus are selected. Selection includes excluding trivial words in the corpus, where trivial words comprising one letter words and numerical characters, and selecting the word pairs based on how frequently the source words of the word pairs occur in the corpus. The relevant word pairs are ranked for use in automatic transliteration. Other embodiments of this aspect include corresponding systems, apparatus, and computer program products.

These and other embodiments can optionally include one or more of the following features. Trivial words can include acronyms. The corpus of word pairs can include user-generated word pairs. Multiple possible transliterations for a source word can be provided to a user. A selection of a first transliteration from among the multiple transliterations can be received from the user. A word pair comprising the source word and the first transliteration are added to the corpus of word pairs. The frequencies of source words can be measured based on a number of documents in which the source words occur. Selecting relevant word pairs can include selecting additional word pairs from the corpus based on a randomized statistically biased selection. Selecting relevant word pairs can include filtering from the selected word pairs based on the respective sources of the word pairs.

In general, another aspect of the subject matter described in this specification can be embodied in a method that includes generating a training model from ranked word pairs. Each word pair in the ranked word pairs includes a source word and a target word. Each source word is specified in a source script and each target word is a transliteration of the corresponding source word in a different, target script. Training model includes alignments between the letters of each of a plurality of source words and the letters of the corresponding target word. Generating the training model includes generating alignments from each of multiple word pairs including: for each word pair, matching the letters from the source word with the letters of the target word of the word pair. The letters are matched based on a statistical likelihood that one or more letters in the source word co-occur with one or more letters in the target word. Other embodiments of this aspect include corresponding systems, apparatus, and computer program products.

These and other embodiments can optionally include one or more of the following features. The statistical likelihood can be measured by Dice coefficients. The letter-to-letter matches can include a k-to-n alignment, where k and n are each integers greater than 2. Some characters in the target script can be ignored or skipped in determining the alignment of letters. Pre-determined consonant maps can be used to map specific letters from source words to target words.

In general, another aspect of the subject matter described in this specification can be embodied in a method that includes clustering users into groups based on usage patterns of the users in selecting or correction transliterations. A transliteration of a word for a first user in a first group is automatically corrected based on corrections made by other users in the first group. Other embodiments of this aspect include corresponding systems, apparatus, and computer program products.

In general, another aspect of the subject matter described in this specification can be embodied in a method that includes clustering users into groups by identifying geographic locations of the users. A transliteration of a word for a first user in a first group is automatically corrected based on corrections made by other users in the first group. Other embodiments of this aspect include corresponding systems, apparatus, and computer program products.

In general, another aspect of the subject matter described in this specification can be embodied in a method that includes recording word pairs for transliteration. Each word pair has a source word in a source script and one or more target words in a different, target script. The method includes generating an entry-aligned dictionary of transliterations. The dictionary includes, for every source word in the dictionary, a single target word. Whenever a particular source word is mapped to multiple target words, then the entry-aligned dictionary includes an entry for each target word, where each entry includes the same source word repeated in each entry. Other embodiments of this aspect include corresponding systems, apparatus, and computer program products.

These and other embodiments can optionally include one or more of the following features. The entry-aligned dictionary of transliterations can include parts of a global dictionary of transliterations. The entry-aligned dictionary of transliterations can include a user's dictionary of transliterations.

In general, another aspect of the subject matter described in this specification can be embodied in a method that includes generating a transliteration model based on statistical information derived from a corpus of parallel text having first text in an input script and corresponding second text in an output script. The transliteration model is used to transliterate a sequence of input characters in the input script to a sequence of output characters in the output script. Other embodiments of this aspect include corresponding systems, apparatus, and computer program products.

These and other embodiments can optionally include one or more of the following features. Multiple input words can be identified from the sequence of input characters. A first portion of the multiple input words can be transliterated, using the transliteration model, based on one or more of: 1) a second portion of the multiple input words preceding the first portion, or 2) a third portion of the multiple input words following the first portion. Each of the first, second and third portions correspond to a word, a phrase, or a sentence in the multiple input words. A transliteration of the first portion can be selected from a plurality of potential transliterations of the first portion based on a statistical likelihood that a potential transliteration in the plurality of potential transliterations co-occurs in the corpus with a transliteration of the second portion preceding the first portion.

Particular embodiments of the invention can be implemented to realize one or more of the following advantages. The rules that govern transliteration are automatically learned from a corpus of examples. The rules that govern transliteration are also learned and improved through use and user interaction. Dynamic rule sets enable transliteration to adapt to the dynamic nature of language and the varying expectations of users. Transliteration rules can be automatically customized for each individual user. Groups of users can be identified, based on geographical location or usage patterns, and can be provided with transliterations that are more likely to meet the particular expectations of users in the group. Transliteration rules can be provided to a client, such as a web browser, to provide interactive and timely transliterations. Common transliterations can be cached to further expedite transliteration. Common transliterations can be provided at least in part to a client to efficiently enable interactive transliteration.

The details of one or more embodiments of the invention are set forth in the accompanying drawings and the description below. Other features, aspects, and advantages of the invention will be apparent from the description and drawings, and from the claims.

### BRIEF DESCRIPTION OF THE DRAWINGS

FIG. 1 is a diagram of a user interface for receiving text for transliteration.

FIG. 2 is a diagram of alignment between characters of a target and source word.

FIG. 3 is a diagram of segmentations of the aligned words shown in FIG. 2.

FIG. 4A is a diagram of segmentations derived from multiple word pairs.

FIG. 4B is a diagram of partially generated potential transliterations.

FIG. 5 is a flow diagram for selecting relevant words pairs from a corpus.

FIG. 6 is a flow diagram for transliterating words.

FIG. 7 shows an input string from which two potential transliterations are derived.

FIG. 8 shows a hierarchy of groups and their associated dictionaries

FIG. 9 is a block diagram of a transliteration system.

Like reference numbers and designations in the various drawings indicate like elements.

### DETAILED DESCRIPTION

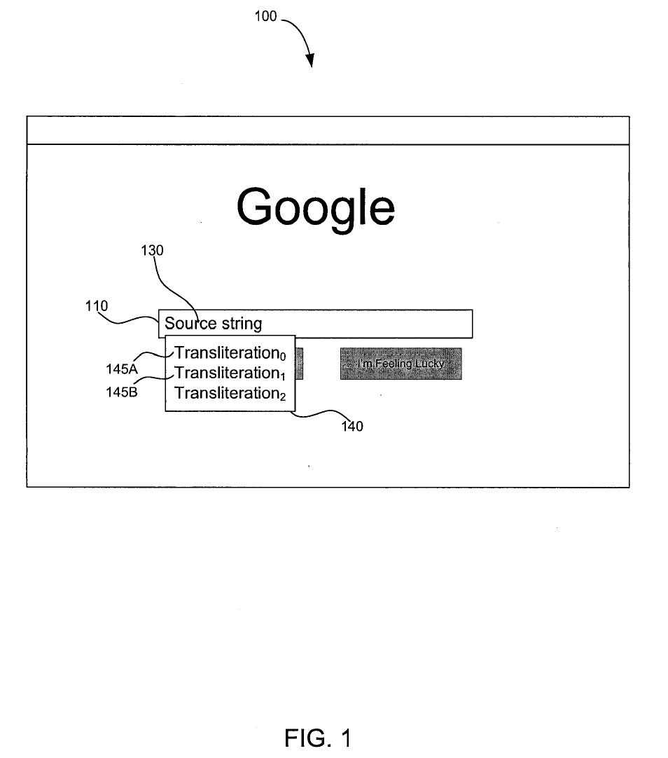

As shown in FIG. 1, an exemplary graphical user interface 100 includes a text box 110 for receiving text-based user input. The graphical user interface 100 can be that of a web page rendered by a web browser 120 or, in other implementations, can be a part of a stand alone application. Textual user input (e.g., the text 130) can be received in the text box 110. The textual user input is provided in a particular input script (e.g., using the Latin alphabet). Generally text is provided by a user using an input device (e.g., a keyboard, a mouse, stylus, or microphone).

Exemplary user input 130 is shown displayed in the text box, representing text received from a user in a particular input script (e.g., Latin alphabet). The user interface also includes a selection list 140. The selection list includes one or more transliterations 145A, 145B. Each transliteration is a string that includes characters in a script other than the input script. The exemplary transliterations 145 are strings in an Indic script, e.g., Devanāgarī, that ideally correspond to the Latin input 130. In general, given a particular string in one script, there could be multiple corresponding transliterations. Transliteration is, in general, an imprecise process that can be dependent on context of both the transliterated string and the expectations of the user. The expectations of a user may be shaped by social norms, personal habits, regional practices or any number of external influences.

The transliterations 145 presented in the selection list 140 can be presented in an order that reflects the likelihood that the transliteration correctly corresponds to one or more words in the input string 130. Whenever a user selects any but the first transliteration in the selection list, that selection can be recognized as a correction. For example, the transliteration 145A is presented first because it is considered the most likely transliteration of the input string 130. If a user selects another transliteration 145B, that selection represents a correction, namely that the second transliteration 145B is considered by the user as a more accurate transliteration than the first transliteration 145A. User corrections can be recorded to improve the accuracy of subsequent transliterations. A record of user corrections identifies characteristics of the correction including the input word (or source word) as well as the transliterated word (or target word) that was selected by the user. In general, correction records generated by multiple users can also include other statistical information. Statistical information can include how many users made the correction and how frequently the correction occurred both absolutely and relatively to the number of times the transliteration was presented (but not necessarily selected).

In some implementations, a user may manually correct a particular transliteration by adding, removing or replacing characters in a transliterated word. For example, a user may use a letter-level transliteration software or a software keyboard to insert individual letters into a transliterated word. Such manually corrected transliterations are also recognized as corrections and can be recorded as such.

Note that context information associated with user interactions can be also be recorded and used to improve the accuracy of subsequent transliterations. Context information can include how a user provided a correction (e.g. selection compared to manual correction) and the time the user provided the corrections. The context information can be used to rank corrections and determine their relative relevance and confidence. In general, any context information can be used to dynamically personalize services for users, as described in U.S. patent application Ser. No. 11/324,736, entitled “Automatically Generating and Maintaining an Address Book”, to inventors Lalitesh Katragadda and Bret Steven Taylor, filed on Dec. 29, 2005, Express Mail No. EV542667757US, U.S. patent application Ser. No. 11/323,482, entitled “Automatically Generating and Maintaining a Personal Data Book”, to inventor Lalitesh Katragadda, filed on Dec. 29, 2005, Express Mail No. EV542667788US, U.S. patent application Ser. No. 11/323,134, entitled “Dynamically Autocompleting a Data Entry”, to inventor Lalitesh Katragadda, filed on Dec. 29, 2005, Express Mail No. EV542667791US, and U.S. patent application Ser. No. 11/323,364, entitled “Dynamically Ranking Entries in a Personal Data Book”, to inventor Lalitesh Katragadda, filed on Dec. 29, 2005, Express Mail No. EV542667805US, each of which applications is incorporated by reference herein.

In some implementations, user input received from the user can be transliterated on a word by word basis. For example, all of a user's text immediately preceding a word-break character (e.g., punctuation, a space, carriage return, end-of-line or end-of-file character) can be transliterated at once as a complete word—even while the user continues to provide additional input. In other implementations, the entire user input provided is transliterated at once (e.g., when the user submits the input or explicitly selects to have user input transliterated on demand). For example, a user can position a cursor over a particular word, and in response, the selection list 140 of transliterations can be presented. In other implementations, word fragments can be transliterated before the user has provided input that completes the word.

Transliteration can be performed between any two scripts where the letters of one script can be expressed using a combination of letters in another script. In the remainder of this specification, the Latin and an Indic alphabet will be used to illustrate concepts of automatic machine-assisted transliteration. In particular, the following specification assumes that source-words, specified in Latin characters, are being transliterated to target-words, specified in Indic characters. Note, however, that the methods and processes described below can apply, in general, between any two differing scripts where transliteration is applicable.

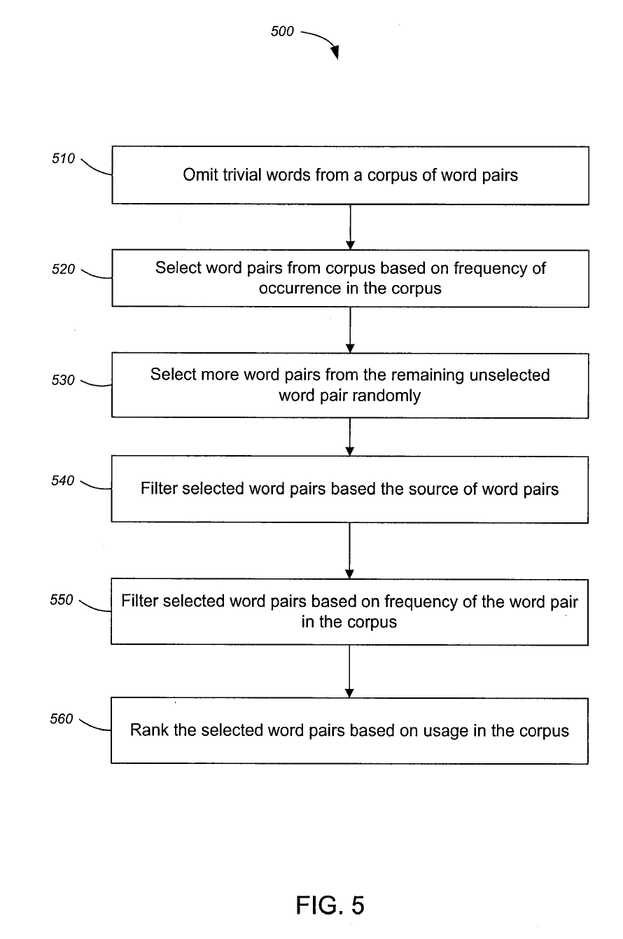

As shown in FIG. 5, a process 500 for selecting relevant word pairs from a training corpus of word pairs (e.g., parallel text) for use with automatic transliteration learning algorithms. Each training pair has a word-set, a source-word and one or more target-words. The following description assumes a single target-word. The source-word is specified in the source script and the target-word is a transliteration of the source-word. The target-word is in the target script. Word pairs in the corpus can be derived from a variety of sources including existing electronic documents and recorded interaction with individual users (e.g., transliteration corrections).

In some implementations, word pairs are automatically derived from electronic documents, such as documents that include parallel text (e.g., text in one script corresponding to a transliteration of text in another script). For example, publicly accessible web pages, which contain parallel text, can include language instruction material and transliteration guidance (e.g., governmental, corporate and academic literature). Suitable documents can be identified based on whether the document includes two different scripts. Well-known text and word alignment techniques can be used to align text within the document and determine whether the text is parallel (e.g., whether the text in one script is likely the translation of text in the other script). Word pairs can be derived based on word alignments between parallel text. Word pairs can be verified by comparing each word's soundex value (or other phonetic metric). In some implementations, scoring can be used to align and match corresponding word pairs in unstructured text. For example, the soundex score of words are used to determine a similarity score for each word in a potential word pair. A potential word pair whose similarly score exceeds a particular criterion threshold can be identified and recorded. Using soundex scoring can help prevent erroneous word pairs (e.g., incorrectly transliterated words) from being subsequently used during automatic transliteration.

The corpus of word pairs can include user generated-word pairs. A user generated word pairs is derived when a user provides or selects one or more transliterations for a particular source-word specified in the input text. For example, a user selecting one of several possible transliterations for a particular input word (e.g., as described in reference to FIG. 1) generates a word pair between the input word and the selected transliteration. User generated word pairs can also be provided by an expert user.

Note that in some language groups, for example Indic languages, it is possible to transliterate the words of one Indic script to the words of another Indic script. These transliterations can often be derived using a small set of deterministically defined transliteration mappings. These mappings can be used to generate multiple corpora in each script which can be transliterated using the mappings. These corpora can subsequently be used to produce word pairs between a source script and a target script. For example, the corpus of each Indic script can be made larger by using the word-pairs of one corpus to generate word-pairs in another corpus, thus making all corpora larger, and ideally more expressive, than would be otherwise possible.

The process 500 includes omitting or ignoring trivial words in the corpus (step 510). Trivial words are words from which meaningful transliteration information cannot be acquired. Trivial words include one letter words and numerical characters. Acronyms can also be ignored. From the remaining word pairs in the corpus, several word pairs can be selected based on how frequently the source-word occurs in the corpus (step 520). In some implementations, selection is based on how often the word appears anywhere in the corpus (e.g., all instances in all documents in the corpus). In other implementations, selection is based on the number of unique documents in which the word occurs (e.g., multiple instances of the same word in a particular document count only as one occurrence). For example, the top 90% of all non-unique words can be selected. Using this method, the number of selected words may be significantly less than the total number of distinct words that occur in the corpus. For example, some estimate that in English fewer than 5,000 unique words are used in 80% of all written texts.

The process 500 includes selecting additional word pairs from the corpus based on any sampling method such as a randomized statistically biased selection (e.g. the higher the frequency, higher the probability of selection) (step 530). For example, an additional 5% of words can be selected that are both non-trivial and not selected (e.g., not among the top 90%). Thus, if 10,000 non-trivial words occur in less than 10% of all documents, then an additional 500 words are randomly selected from the 10,000 words.

The process 500 includes filtering from the selected word pairs based on the source of a word pair (step 540). The sources from which each word pair originates can be grouped into entities. Words that originate from users can be grouped according to the particular user. Words that originate from web pages or documents can be grouped according to an associated characteristic of the document (e.g., domain name, article, author, directory, or database). Words that have been used by only a few entities (e.g., three or less) can be filtered (e.g., ignored or omitted). Alternatively, a squashing function can be used to score each word based on how often the word occurs both across different entities and within a particular entity, and words below a pre-defined score can be filtered. These filtered words are removed because their narrow usage suggests obscure, specialized or errant use. Each of the word pairs can be weighted based on their source (e.g., particular user or location). For example, the word pairs provided by a language expert or derived from a user correction (e.g., as described in reference to FIG. 1) can be given more weight compared to the same word pair derived from another source.

The process 500 includes filtering from the selected word pairs based on the frequency of a word pair in the corpus (step 550) (e.g., based on how often the target-word or source-word appears in the corpus). In some implementations, a threshold can be used to filter all word pairs that include a word that infrequently occurs in the corpus. A word pair can be filtered if it the target-word occurs proportionally very rarely compared to other target-words that all share the same source-word. A word pair can be filtered if the target-word occurs proportionally rarely compared to all other words in the target script (e.g., words that occur less than 2% of the time, compared to all other words in the same script).

In some implementations, all of the above filtering techniques can be used as an aggregate of signals. A single filtering function can be used to score a word pair based on its signals, whereby any word pair with sufficiently low score is subsequently omitted.

The remaining selected word pairs are ranked (step 560). The rank of a word pair is a function of the number of times the word pair occurs in the corpus, a confidence signal and the weight of the word pair. The confidence signal is based on the number of unique word-pair sources (e.g., distinct users and document sources) which have used the transliteration represented by the word pair. In some implementations, word pairs can be ranked according to a squashing function (e.g., using values 1, 10->2, 100->10). The number of unique word-pair sources can be squashed to some small, maximal value for frequently occurring word-pairs, while the value of less frequently occurring words are boosted relatively. The squashing function is a non-linear function used to normalize linear predictions into probabilities (e.g., that range between 0 and 1).

Alignment

A training model is generated using the ranked word pairs. Generally, the training model includes alignments between the letters of a source word and the letters of the source word's corresponding target word. An alignment between source letters and target letters ideally identify letter transliterations (e.g., the source letters are a transliteration of the target letters and vice-versa). Given a particular word pair, the letters from the source word are matched with the letters of the target word. Letters are matched based on the statistical likelihood that one or more letters in the source word co-occur with one or more letters in the target word. In some implementations, co-occurrence probabilities are measured by Dice coefficients. However normal alignment techniques are relatively unconstrained and purely Dice-based alignment can be error-prone. In general, letter-level alignment is a many-to-many mapping of characters, however in practice, alignments are typically one-to-one, two-to-one, one-to-two, one-to-three, or three-to-one mappings.

In determining the alignment of letters, some characters in the target script can be ignored or skipped. For example, in some Indic scripts, a class of characters known as viramas can be skipped during alignment. Even if viramas are skipped for alignment, they may still be considered during subsequent analysis (e.g., distance scoring and segmentation, as described below).

Pre-determined consonant maps can be used to map specific characters from the source word to characters of the target word. Generally, consonants produce well-defined sounds. The consonants of one script map to one or a small number of consonants letters in another script. Consonant maps can be pre-determined by an expert user, or can be learned in a separate consonant mapping process. Consonant maps provide additional constraints during alignment requiring a specific consonants in the source word to map to one of a specific consonants in the corresponding word. Using consonant maps reduces the number of potential alignments, reducing the search space, increasing efficiency and reducing the likelihood of alignment error.

When the characters of a word in both the source and target scripts are pronounced in the order written (e.g. left to right or right to left, where the source and destination languages could be in opposing orders), a monotonic constraint can be used to constrain alignment mapping. The following description assumes that both source and destination are in the same direction. The monotonic constraint requires that the beginning and end of a source and corresponding target word align. Moreover, the character preceding an aligned sub-part of the source word must align with the preceding character of the corresponding sub-part of the target word. The monotonic constraint makes alignment mapping a smaller, linear, chained-alignment problem.

Using these constraints where the alignment score is a number, the alignment problem can be treated as a discrete or non-linear, constrained optimization problem, and techniques like BFGS (Broyden-Fletcher-Goldfarb-Shanno method), simulated annealing, SPSA (simultaneous perturbation stochastic approximation) can be applied to finding an optimal or near optimal solution.

In some implementation, a monotonic constraint is used as a potential field (energy field) when aligning word-pairs using a constraint-based optimization. Under the monotonic constraint a measure of distance between the first (and last) character of one word and the first (and last) character of the corresponding word is zero. The distance between corresponding consonants (e.g., based on the consonant maps) is also zero. The distances of all other characters are measured with respect to these zero points. The probability of a character in one word mapping to a character in the corresponding word is highest if their respective distances from corresponding zero points are the same. The probability decreases as the difference in distances increase. Using the monotonic constraint to set distance values makes the alignment mapping a smaller optimization problem. Here silent characters like viramas can be used to modify the distance functions.

In some implementations, additional constraint rules can be used to simplify the alignment mapping. The inherent language-based characteristics of a script can be used to derive special constraints. In Indic scripts, for example, matras are characters that represent a phonetic modifier to a consonant. Special rules that map matras to particular character can be used to improve alignment. Matras in an Indic-script word can be represented in a corresponding Latin-script transliteration as a vowel or as no character at all, depending on preceding characters. These conventions can be encoded as constraint rules. One such rule restricts which characters occur after a Latin character representing a corresponding Indic character. For example, the matra ‘ [symbol] ’ (in [symbol] ) extends the preceding sound with ‘aa’ or ‘ah’. A rule can indicate that the letter ‘a’ occurring after another letter that aligns with an Indic consonant character (e.g., [symbol] ) will most likely align with the matra following the consonant character, if such a matra exists.

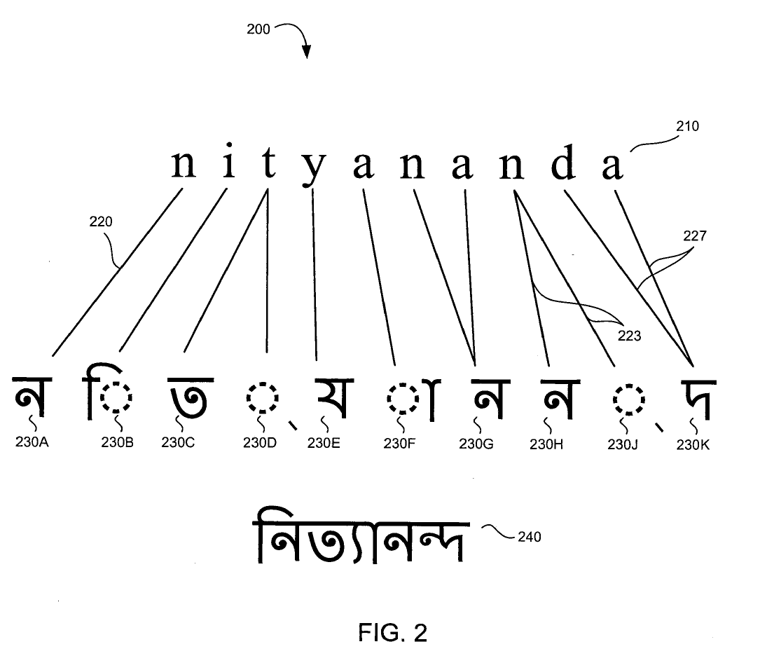

FIG. 2 is an illustration 200 of an alignment between characters in a source word 210 and a target word 240. The source word 210 is specified in Latin script while the target word 240 is specified in Devanāgarī script. The target word 240 includes the ten characters 230A-230K. Note that the rendering of the target word 240 can appear to betray the actual order of the word's constituent characters. The ten individual characters 230A-230K are shown in their actual order (e.g., the character 230A is in a memory location successive to the memory location of character 230B). Some characters between the source and target words align one-to-one, such as the alignment 220 between the first ‘n’ in the source word 210 and character 230A. Other characters align one-to-two, such as the alignment 223 between the last ‘n’ in the source word 210 and the characters 230H and 230J. Still other characters align two-to-one, such as the alignment 227 between the two last characters of the source word 210 and character 230K. In general, other alignment combinations are also possible.

Segmentation

One or more letter alignments between a word pair can be grouped together producing a segmentation consisting of one or more contiguous alignments. The segmentation of a word pair effectively provides a mapping of a segment (e.g., one or more letters) from a source word to a segment in a target word. Each segmentation represents a transliteration that can potentially be applied to another source-word.

In general, a word pair may be used to generate multiple varying length overlapping segments; however, each segment obeys intra-word alignment boundaries. In some implementations, alignments between consonants are used to constrain segmentation. Consonant alignments are used as a boundary to limit segmentation, which effectively prevents coalescing letters on both sides of a consonant into a single segment.

Each segment can be associated with an occurrence or frequency property whose value is based on how often the segment (e.g., a particular sequence of letters) occurs within the corpus. This property can be expressed as a segment prior probability derived from the number of times the segment occurs in the corpus relative to all other segments. Each segmentation can also be associated with an occurrence or frequency property whose value is based on the number of times the segmentation can be derived from word pairs in the corpus. This property can be expressed as a segmentation prior probability derived from the number of segmentations relative to all other segmentations.

Each segment and segmentation can be associated with information about its conditional probability. The conditional probability of a segment indicates the probability that a particular series of target letters is generated given a particular series of source letters.

Statistical similarity (co-occurrence) metrics, such as Dice's coefficient, which measures the correlation between discrete events, can be used to measure the likelihood of a particular segment mapping to one or more corresponding segments. Each potential segmentation can be scored based on the frequency of occurrences in the corpus and a confidence signal (e.g., how many times the segmentation is used by users). Segmentations whose scores are not enough to exceed a preset threshold can be removed, omitted or ignored.

Segmentation rules can be used to aggregate segments. For example, in Indic scripts, a segmentation rule can specify that viramas, which are particular characters that occur before or after consonants, can be collapsed with (e.g., added to) their associated consonant into the same segment. Accents (e.g., a matra) that follow a consonant can be collapsed with the consonant. Accents and viramas can be recursively collapsed to generate larger segments.

Individual segments can be associated with information identifying whether the segment is a prefix or suffix depending on whether the segment occurs most frequently at the beginning or end of the word. Common prefixes and suffixes are can be identified from specific target-script letter sequences that frequently occur at the beginning or end of a word. A corresponding suffix or prefix in a source-script can be identified where the occurrence of a particular source-script letter sequence correlates with a corresponding occurrence of the target-script suffix or prefix. Prefixes and suffixes are automatically detected based on frequency of occurrence in the corpus and conditional probability correlation.

A particular segmentation can be checked by computing a soundex value for the source segment and its corresponding target segment. Segmentations whose soundex values are determined to be significantly different can be removed, omitted or ignored. In addition to computing soundex values, other phonetic comparisons (e.g., pre-defined consonant maps, matra-vowel maps and syllable maps) can be used to verify segment mappings.

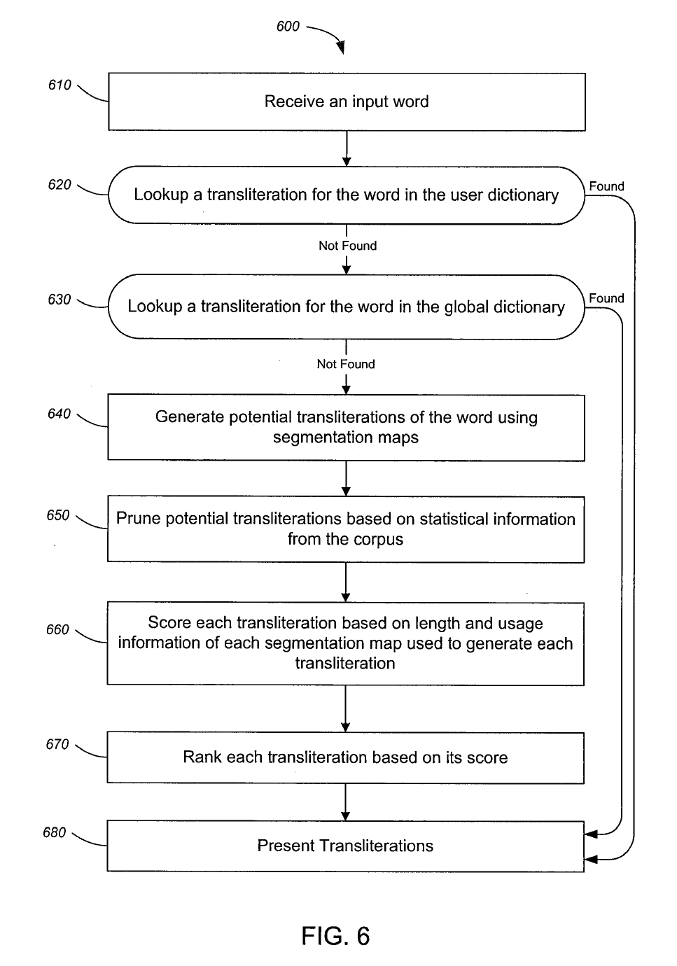

In addition to alignment and segmentation, statistical information about the corpus can be collected. This information can include the probability that particular pairs, triples, four-tuples, and n-tuples of characters follow each other consecutively. Additionally, statistical information can be collected about consecutive character-class pairs, and prefix and suffix segments. Character classes include consonants, vowels, consonant clusters (e.g., consecutive consonants), vowel clusters (e.g., consecutive vowels e.g. occurring for matras), accented characters, or viramas. For example, statistics identifying the probability that a particular consonant cluster follows another consonant cluster or that a particular accented character precedes a particular vowel can be collected. Statistical information can also be collected which describes the likelihood that a character or character class has particular characteristics with respect to the word in which the character is found (e.g., whether a character is usually accented, appears at the beginning or end of the word, or is followed or preceded by a virama). This statistical information can be generated for all corpora and can be used to determine whether a potential automatic transliteration is likely valid or not. This statistical information can also be verified to check validity and usefulness of particular segments. Automatic transliteration is described in further detail in reference to FIG. 6.

Not all possible consonant and vowel combinations or all possible consonant clusters may be encountered in the training corpus. Information about additional combinations or consonant clusters can be generated using one and two letter generation rules, which can include language specific information (e.g., accents and viramas). These generation rules can be provided by expert users.

A global dictionary of common transliteration mappings can be recorded. That is, a source word that occurs in the corpus with sufficient frequency can be recorded in the global dictionary with the source word's corresponding target words. This global dictionary serves as a transliteration cache from which the transliteration of common words can be quickly and easily retrieved. A global dictionary can be generated for each script or corpus.

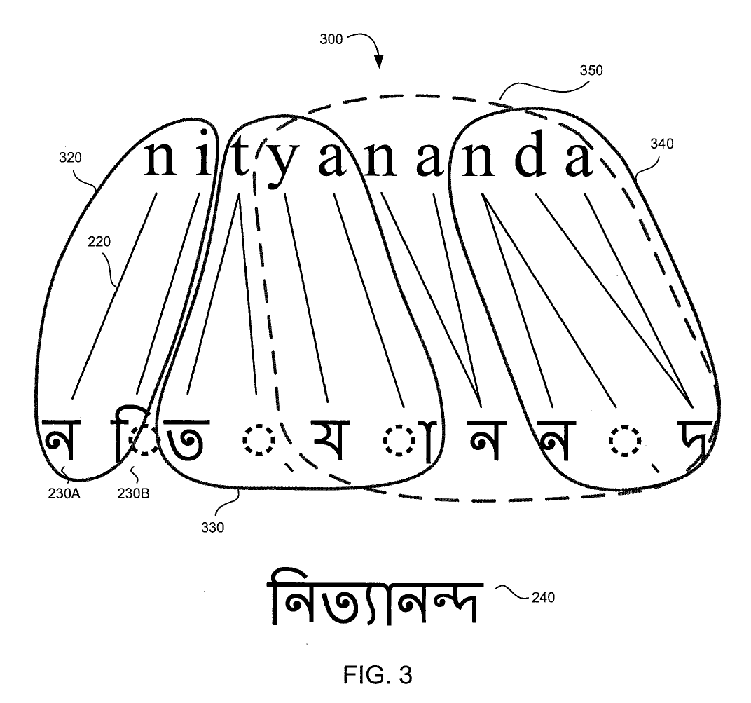

FIG. 3 is an illustration 300 of segmentations of the aligned words shown in FIG. 2. The segmentation 320 includes the first two alignments and represents a mapping of ‘ni’ source-word characters to the characters 230A and 230B of the target word 240. Likewise, the segmentation 330 includes the next three alignments. The segmentation 340 includes the last two alignments between the source and target word. The segmentation 350 includes the last five alignments and overlaps with the segmentation 340 (e.g., the last two alignments are in both segmentations). Notice that each segmentation obeys the character alignments between the words (e.g., no segmentation crosses an alignment boundary). Although, only four alignments are shown, in general, the word pair can be used to generate as many segmentations as possible (e.g., every combination of contiguous alignments).

Transliteration

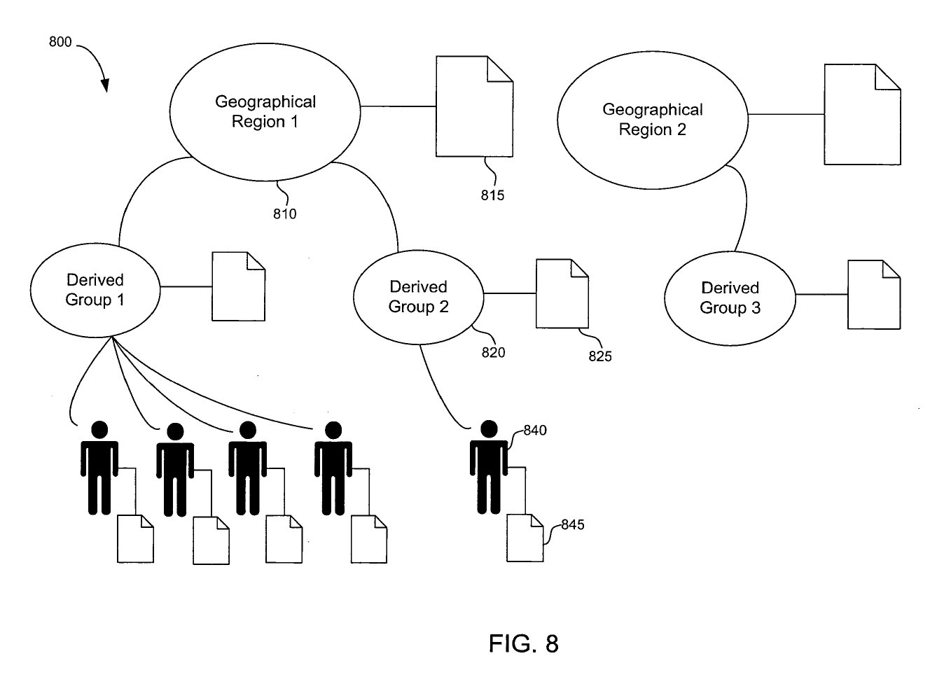

As shown in FIG. 6, a process 600 for transliterating a source word includes receiving a source word from a user (step 610). In some implementations, the particular user can be identified, separate from all other users from which source words may be received. For example, a user accessing transliteration through the use of a web browser can be identified through login authentication, session keys, cookies, IP addresses or a combination thereof. In such implementations, an identified user has a profile which can include a user transliteration dictionary. A user transliteration dictionary identifies particular source words and respective target words that the user has identified. In particular, the user's transliteration dictionary can include mappings that have been explicitly or implicitly identified by the user (e.g., when the user makes a correction). A user's transliteration dictionary may differ from the global dictionary. A user transliteration dictionary is described in further detail below in reference to FIG. 8.

If the source word is found in the user's transliteration dictionary, the corresponding target word can be provided to the user (step 620). Otherwise, the source word is used to search the global dictionary of common transliteration mappings (step 630). If the source word is found in the global dictionary, the corresponding target word can be provided to the user. The global dictionary can include region specific or group specific dictionaries that the user may belong to. In one implementation, the more specific the group, the higher the priority of that dictionary for the user. The most specific group being the user's personal dictionary, as described in reference to FIG. 8.

If the source word is not found in either the global or user dictionary, the source word can be transliterated as a sequence of segments. For a given source word, a list of potential transliterations are generated (step 640). The generation of potential transliterations can begin by matching either prefix segments or suffix segments, or by matching both prefix and suffix segments. The portion of the word that remains (e.g., end, beginning or middle, respectively) can be generated by applying segment maps using a greedy approach, simulated annealing or other stochastic search method. Alternatively, the entire word can be transliterated by the application of segment maps in no particular order using a global optimization approach.

For example, a source word can be transliterated by first identifying all applicable prefix and suffix segments based on the letters in the source word. All of these segments, in combination constitute a list of potential partial transliterations. Each partial transliteration includes only prefix and suffix segments. A partial transliteration will also include some unmapped letters of the source word, namely those letters between the end of the prefix and the beginning of the suffix. The partial transliteration can be “filled in” by applying additional segment maps. Applying the segment maps can produce additional transliterations if more than one segment mapping applies to a particular combination of characters in the source word.

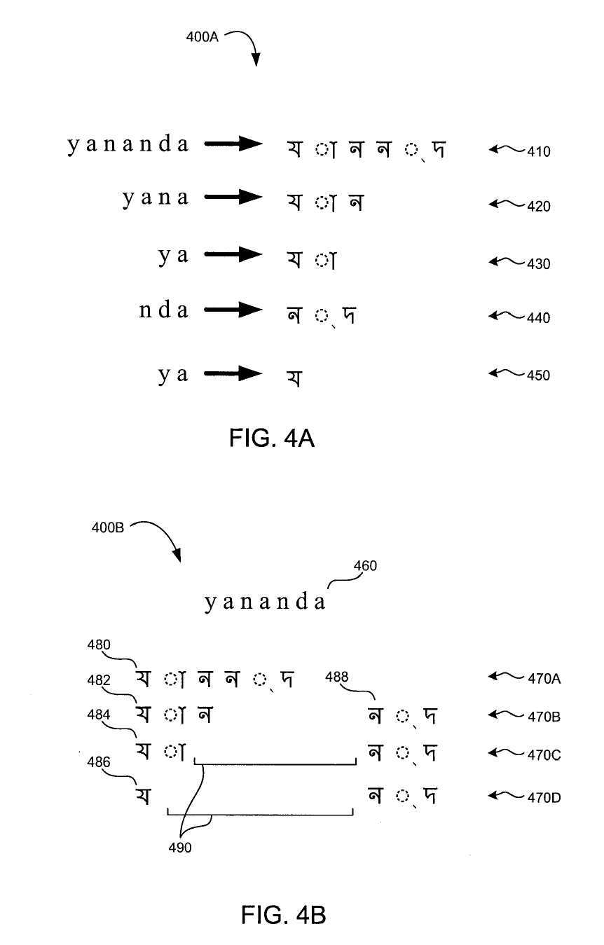

For example, FIG. 4A is an illustration 400A of segmentations 410-450 derived from multiple word pairs. The segmentations 410-440 are exemplary segmentations that can be derived from the word pair illustrated in FIG. 3. The segmentation 450 is a segmentation that is derived from another word pair. Each segmentation represents a mapping of word segments in the source script (e.g., Latin) to word segments in the target script (e.g., an Indic script). As described above, some of these segmentations can be associated with information identifying whether the segmentation is a prefix or a suffix. The segmentations 410-430, each derived from the beginning of the word pair in FIG. 3 are prefix segmentations. The segmentation 440 is derived from the end of the same word pair and can be designated as a suffix segmentation. The segmentation 450 is not derived from the word pair shown in FIG. 3, this segmentation is assumed to be derived from another word pair where ‘ya’ maps to ‘ [symbol] ’. Although only five segmentations are illustrated in FIG. 4A, the segmentations derived from all word pairs in the corpus are typically used to transliterate a word.

FIG. 4B is an illustration 400B of generating potential transliterations 470A-D for an input string 460. Each potential transliteration 470A-D is generated based on the segmentations shown in FIG. 4A. For example, the potential transliteration 470A is generated from the segmentation 410. The potential transliteration 470B is generated from the prefix segmentation 420 and the suffix segmentation 440. Every character of the input string 460 is used to generate characters in the potential transliterations 470A-B. In contrast, the potential transliterations 470C-D do not map every character from the input. Instead, each of these transliterations are generated based on the suffix segmentation 440 and two distinct prefix segmentations 430 and 450. The prefix segmentation 430 and 450 map that same source-word characters to distinct target-word characters, so each segmentation is used to derive a potential transliteration. These transliterations 470A-D are generated from all combinations of prefix and suffix transliterations illustrated in FIG. 4A. The blank 490 represents the characters in the target word that are unknown. The unmapped characters of the potential transliterations 470C-D can be used to generate missing characters to fill in the blank 490. Each potential transliteration 470A-D is subject to pruning and scoring to identify a likely transliteration for the input string 460.

Referring again to FIG. 6, as potential transliterations are generated, the statistical information collected from the corpus is used to prune unviable transliterations (step 650). Unviable transliterations are potential transliterations that exhibit letter and segment patterns that are not supported by the statistical information collected from the corpus. For example, if, according to corpus statistics, there are no words that begin with an accent, then all potential transliterations with an initial accent can be pruned. All aspects of the statistical information collected from the corpus can be used to prune potential transliterations (e.g., prefix/suffixes, segment combinations, character pair and character-class pair co-occurrences, and other letter characteristics). In some implementations, a threshold can be specified to further increase the pruning rate. The threshold can specify that the statistical information from the corpus must exceed a particular value before a transliteration is considered viable. Therefore, characteristics of the potential transliteration (e.g., character-class combinations, suffixes, prefixes and so on) must not only have occurred in the corpus but must constitute a certain proportion thereof. For example, a particular segment may occur as a prefix in only 1% of all words in which the segment occurs. A potential transliteration that has the particular segment occurring as a prefix can be pruned if 1% does not exceed the threshold value.

In some implementations, special characters can be inserted between segments that are otherwise not viable. For example, a special character can be inserted between a segment that ends with a consonant and the next segment that begins with a consonant. The special character can be later mapped to a vowel and is added to a potential transliteration when doing so would increase the score of the potential transliteration significantly.

All potential transliterations are scored based on the conditional and prior probability and the length of each segment used to generate the transliteration (step 660). In general, long segments are scored more favorably than short segments because a longer segment typically represents a more specific and, ideally, a more accurate transliteration. In some implementations, the transliteration can be scored based on the prior and conditional probability of the entire word (e.g., rather than an individual segment). Transliterations can also be scored based on co-occurrence probabilities of each segment pair in the potential transliteration. The contribution of each segment to the score of the transliteration can be additive, multiplicative or some other monotonically increasing function.

Other words in the input string can be used to contextually score potential transliterations. In some implementations, if the score of several transliterations are all below a particular threshold value or alternatively, if the score of the transliterations are all near in value, then the score of each transliteration can be re-evaluated based on other words in the input string. In particular, the preceding or following words from the input string can be used. In some implementations, multi-word (e.g., phrase or sentence) matching can be used with preceding or following characters in the input string. The prior probability of word co-occurrences (e.g., according to the corpus) can be used to augment the score of each transliteration, ideally identifying a likely transliteration from among several.

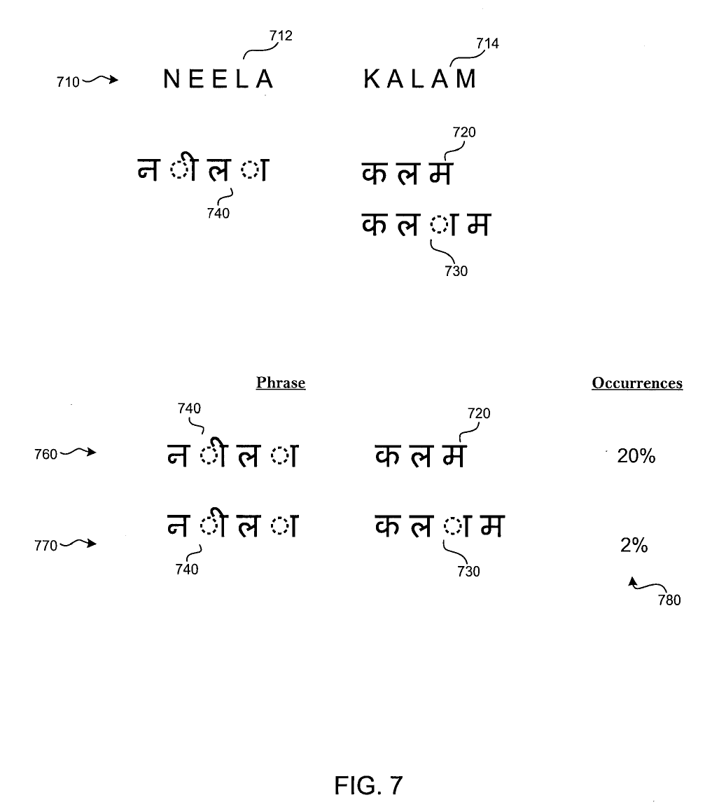

For example, FIG. 7 shows an input string 710 from which two equally viable transliterations are derived 760 and 770. The input string 710 includes two words, the first word 712 corresponds to the transliteration 740. The second word 714 has an ambiguous transliteration as it can be transliterated into either of the words 720 or 730. Both transliterations 720 and 730 are equally viable transliterations of the second word in the string 710. The complete combined transliteration of the whole input string 710 can either be 760 or 770. The relative occurrences 780 of each whole transliteration can be considered to determine which of the combined transliterations is likely more accurate. If the string 760 occurs more frequently than 770 in the corpus, then the score of the transliteration 720 can be improved relative to the transliteration of 730. In some implementations, rather than consider the relative occurrence of whole transliterations, only n-word portions of the transliteration, which includes the ambiguous transliteration, are considered. For example, in a four word transliteration that included a word transliterated from the word 714, the potential transliterations for 714 are grouped in a 2-word portion including a transliteration for a single preceding or succeeding word. The relative occurrence in the corpus of the n-word portion is used to score each potential transliteration of the source-word. In general, the portion of the input string 710 being transliterated and the preceding and following portions of the input string used to affect the transliteration can each correspond to a word, multiple words (e.g., a phrase) or sentences.

Referring again to FIG. 6, each potential, viable transliteration is ordered or ranked based on the respective score of the transliteration (step 670). The transliterations are presented in order to the user (step 680). If the user corrects the transliteration (e.g. selects any but the first transliteration in the ordered list), then the corrected word is added to the user's dictionary. All transliterations used by the user (e.g., whether corrected or not) can also be added to the training corpus, thus altering corpus and segmentation statistics. Transliterations of the same source word by a particular user can be added to a user's inferred dictionary. For example, if the user accepts the first word, the word is added to the inferred dictionary and can be used to boost the score of subsequent potential transliterations. In some implementations, users can be clustered into groups of users together based on their usage patterns. A group of users who make one or more particular transliteration corrections can be recognized by statistical correlation—or by applying any collaborative filtering method. For example, a culturally similar group of users can be identified based on their input, transliteration choices, and other context information such as their geographical location (e.g., based on the user's IP address or information in the user's profile), language preference, age, place of birth and so on.

The users in a group share at least one particular commonality. User groups can be used to refine the transliterations provided to users of the group and to use for other services that may require personalization. The transliteration of words for these recognized users can automatically be corrected based on corrections made by other users in the group. In some implementations, user groups can also be identified based on words that are most frequently transliterated by the user. A particular group of users may be more likely to use and transliterate particular words than another group of users. Transliteration conventions often differ from one geographic region to another, so the usage pattern of users from a particular geographical region can be used to adapt transliterations for those users.

In general, user groups can be associated with particular group specific transliteration information. For example, a particular group is associated with unique segment mappings, and group-specific transliteration statistics such as segmentation frequency, word pair frequency and prior probability information. This transliteration information can be based on transliteration selection and corrections by users in the group. The transliteration information can be included in a group dictionary which can include word pairs that are frequently used by users within the group. The global dictionary, one or more group dictionaries and a user's own personalized dictionary represent a prioritized hierarchy of dictionaries that can affect a particular user's transliterations.

FIG. 8 shows a hierarchy 800 of groups and their associated dictionaries. The transliteration information applicable to all users (e.g., the global dictionary and corpus-wide transliteration statistics) is not shown but assumed to exist as the root of such a hierarchy. A first group 810 is a group derived based on a particular geographical location of users. The first group 810 has an associated groups-specific transliteration information 815 identifying particular transliterations often used by users of the group 810. The group may be one of other groups that respectively correspond to other particular geographical locations. The first group 810 includes at least two other sub-groups. For example, the group 820 may correspond to users in the first group that correspond to users having a particular language preference. The group 820 is also associated with group-specific transliteration information 825. In general, a user may belong to many groups at many varying levels in a hierarchy of groups. One particular user 840 in the group 820 is also associated with a personal transliteration information 845, such as the user's personalized transliteration dictionary or the user's inferred dictionary.

When the user 840 provides user input for transliteration the transliteration information associated with the user, and the user's groups, can be consulted in order of personalization. For example, the entries of a user's personalized transliteration information 845 can be used first, the transliteration information 825 of sub-group 820 used second, the transliteration information 815 of group 810 used third and the global transliteration information used last. In some implementations, the information associated with all relevant transliteration information applicable to a user is used simultaneously. The information of each group can be weighted, (e.g., during potential transliteration generation and scoring) according to relevance of the group with respect to the user.

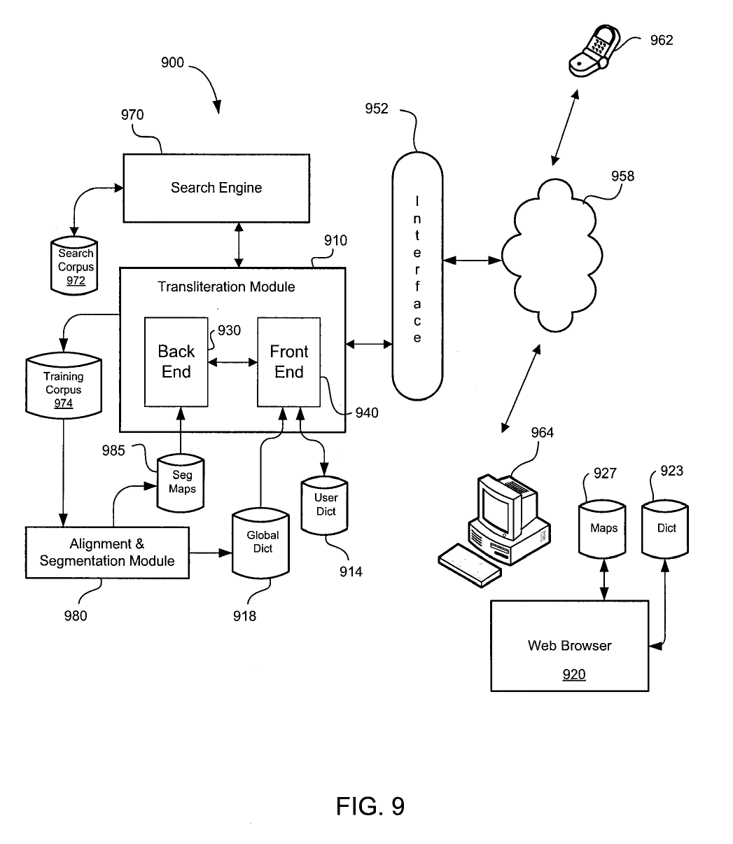

FIG. 9 is a block diagram of a transliteration system 900 for providing transliterations responsive to user requests includes a transliteration module 910. In some implementations, user input is received by the transliteration module 910, upon which transliteration is performed. The transliteration module 910 provides a transliteration of the user input back to the user. In some implementations, the transliteration module 910 is a server that communicates with a client 920 such as a web browser, which is running on a device (e.g., a computer 964 or portable device 962) connected to the server using a wired or wireless network 958. The client 920 provides user input to the transliteration module 910 using any convenient data submission techniques. For example, the system 900 can provide a user interface 952 to the client 920 in accordance with the hyper-text transfer protocol (HTTP).

In some implementations, the client 920 can include client-side scripting capabilities that allow instructions to be received from the transliteration module 910 that are executed by the client 920. These instructions can be specified in client-side scripting languages such as JavaScript, VBScript, Flash, and others. In some implementations, the transliteration module 910 can provide data and client-side instructions to enable the client to generate complete or partial transliterations within the client 920. For example, the transliteration module 910, can provide the client with a client-side copy of the user's transliteration dictionary 923 (or common words from the global transliteration dictionary). The client will also receive instructions that enable the client to automatically transliterate words that appear in the client-side dictionary without further interaction with the transliteration module 910.

In another example, several segment maps 927 can be provided to the client along with instructions such that the client can generate viable transliterations for some words through application of the segment maps. The segment maps sent to the user can be identified based on a confidence score of the map and the frequency with which the map is used to produce a successful transliteration. Thus, the segments that are both likely to be correct and often used can be provided to the client for client-side transliteration. If a transliteration cannot be computed on the client (e.g., the word is not in the user's dictionary, or the provided rules are insufficient) the text can be provided to the transliteration module 910.

The particular maps and dictionary entries that are provided to the client compared to the maps and dictionaries that reside only on the server can depend on a caching strategy. In particular situations the caching strategy can require that all transliteration occur on the server-side without client-side computation (e.g., unsupported web-browsers, mobile devices, slow devices, memory-constrained devices). In other situations the caching strategy can require that maps and dictionary entries are provided to the client for client-side computation. The selected mapping strategy can depend on the words being transliterated, the capabilities of the client, the capacity of the network connection or a combination thereof.

In some implementations, transliteration module 910 includes two sub-modules, a back end 930 and a front end 940. Each sub-module can be distinguished by its role in transliteration. The front end can include the user dictionary 914 and the global dictionary 918. The front end, on receipt of a particular input string, can attempt to transliterate the string based on word look-ups each dictionary. The back end can include a transliteration processor for transliterating a word algorithmically based on segmentation maps 985 and the training corpus of word pairs 974 (e.g., using corpus-related statistics such as prior probabilities). In some implementations, the training corpus of word pairs 974 is derived from the search corpus 972. The front end can ideally transliterate many common words while the back end transliterates the obscure or rare words that the front end is unable to translate directly.

The caching behaviors of the front and back end can reflect the unique role of each sub-module during transliteration. For example, the front end can cache the top 500 transliterations in the global dictionary, while the back end caches the top 1000 segmentation maps. Caching policies affecting how often caches are refreshed or when cache items are replaced (e.g., based on least-recently-used (LRU) or least-frequently-used (LFU) cache algorithms).

In some implementations, the transliteration provided by the client may be undesirable. The user can provide user input indicating that the user would prefer to select a transliteration from other potential transliterations. In response, the word can be provided to the transliteration server 920, and potential transliterations can be received from the transliteration server 920 and presented to the user.

The system 900 can include an entry-aligned dictionary of transliterations. The entry aligned dictionary of transliterations includes, for every source word in the dictionary, a single target word. The dictionary can include parts of the global dictionary of transliterations and or the user's dictionary of transliterations. If a particular source word can be mapped to multiple target words, then the entry-aligned dictionary includes an entry for each target word, where each entry includes the same source word repeated in each entry.

The entry-aligned dictionary is a space-efficient way to record word pairs. A consecutive word stream of the same language and encoding will compress (e.g., using convention compression techniques) more effectively than alternating languages and encodings. Moreover, each word in the entry-aligned dictionary has a simple one-to-one relationship and therefore does not require any special structural overhead for recording potential alternatives. In some implementations, for example, the entry-aligned dictionary can be provided by the system 900 to the user's client 920. The client 920 can subsequently use the dictionary to transliterate words that appear in the dictionary. In such implementations, where the server is a web server and the client a web browser, compression can be achieved by HTTP compression as specified in the HTTP 1.1 protocol standard.

The system 900 can include an alignment and segmentation module 980. The alignment and segmentation module 980 can analyze the training corpus 974 to derive alignment, segmentation maps, transliteration dictionaries and corpus statistics. In some implementations, the analysis of the training corpus is conducted asynchronously from receiving user input or generating potential transliterations for such user input.

The system 900 can include a search engine. The search engine receives a source word as a search query. The source word can be transliterated producing, potentially, several transliterated words that can be used to replace or amend the search query.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
receiving from a user an input of a sequence of multiple input characters entered in an input script, the sequence being terminated by entry of a word-break character, the word-break character not being part of the sequence; and
using a transliteration model after entry of the word-break character to determine an output word in an output script from the sequence of multiple input characters.

2. The method of claim 1, wherein the transliteration model comprises:
a plurality of segments, each segment mapping one or more characters of the input script to one or more characters of the output script.

3. The method of claim 2, wherein each segment in the plurality of segments corresponds to a word pair in a corpus of word pairs, each segment having a score based on a frequency of occurrence of the word pair in the corpus of word pairs.

4. The method of claim 3, wherein using the transliteration model comprises:
generating potential transliterations from the segments, each potential transliteration being derived from a combination of one or more segments; and
selecting the transliteration to use to determine the output word based on the scores of the segments in each of the potential transliterations.

5. The method of claim 4, further comprising:
pruning potential transliterations that exhibit letter and segment patterns that are statistically unlikely in reference to statistics collected from the corpus of word pairs.

6. The method of claim 1, wherein the transliteration model includes:
a dictionary having entries in the input script and, for each entry, a corresponding word in the output script.

7. The method of claim 1, wherein the word-break character is a space character or an end-of-sentence character.

8. The method of claim 1, further comprising replacing the sequence of multiple input characters in a user interface with the output word in the output script.

9. The method of claim 1, further comprising:
receiving input generated from an input device configured to generate characters in the input script.

10-31. (canceled)

32. A method comprising:
generating a transliteration model based on statistical information derived from a corpus of parallel text having first text in an input script and corresponding second text in an output script; and
using the transliteration model to transliterate a sequence of input characters in the input script to a sequence of output characters in the output script.

33. The method of claim 32, further comprising:
identifying multiple input words from the sequence of input characters;
transliterating, using the transliteration model, a first portion of the multiple input words based on one or more of:
a second portion of the multiple input words preceding the first portion, or
a third portion of the multiple input words following the first portion.

34. The method of claim 33, wherein the each of the first, second and third portions correspond to a word, a phrase, or a sentence in the multiple input words.

35. The method of claim 33, further comprising:
selecting a transliteration of the first portion from a plurality of potential transliterations of the first portion based on a statistical likelihood that a potential transliteration in the plurality of potential transliterations co-occurs in the corpus with a transliteration of the second portion preceding the first portion.

36. A computer program product, encoded on a computer-readable medium, operable to cause data processing apparatus to perform operations comprising:
receiving from a user an input of a sequence of multiple input characters entered in an input script, the sequence being terminated by entry of a word-break character, the word-break character not being part of the sequence; and
using a transliteration model after entry of the word-break character to determine an output word in an output script from the sequence of multiple input characters.

37. The program product of claim 36, wherein the transliteration model comprises:
a plurality of segments, each segment mapping one or more characters of the input script to one or more characters of the output script.

38. The program product of claim 37, wherein each segment in the plurality of segments corresponds to a word pair in a corpus of word pairs, each segment having a score based on a frequency of occurrence of the word pair in the corpus of word pairs.

39. The program product of claim 38, wherein using the transliteration model comprises:
generating potential transliterations from the segments, each potential transliteration being derived from a combination of one or more segments; and
selecting the transliteration to use to determine the output word based on the scores of the segments in each of the potential transliterations.

40. The program product of claim 39, further operable to perform operations comprising:
pruning potential transliterations that exhibit letter and segment patterns that are statistically unlikely in reference to statistics collected from the corpus of word pairs.

41. The program product of claim 36, wherein the transliteration model includes:
a dictionary having entries in the input script and, for each entry, a corresponding word in the output script.

42. The program product of claim 36, wherein the word-break character is a space character or an end-of-sentence character.

43. The program product of claim 36, further comprising replacing the sequence of multiple input characters in a user interface with the output word in the output script.

44. The program product of claim 36, further operable to perform operations comprising:
receiving input generated from an input device configured to generate characters in the input script.

45-66. (canceled)

67. A computer program product, encoded on a computer-readable medium, operable to cause data processing apparatus to perform operations comprising:
generating a transliteration model based on statistical information derived from a corpus of parallel text having first text in an input script and corresponding second text in an output script; and
using the transliteration model to transliterate a sequence of input characters in the input script to a sequence of output characters in the output script.

68. The program product of claim 67, further operable to perform operations comprising:
identifying multiple input words from the sequence of input characters;
transliterating, using the transliteration model, a first portion of the multiple input words based on one or more of:
a second portion of the multiple input words preceding the first portion, or
a third portion of the multiple input words following the first portion.

69. The program product of claim 68, wherein each of the first, second and third portions correspond to a word, a phrase, or a sentence in the multiple input words.

70. The program product of claim 68, further operable to perform operations comprising:
selecting a transliteration of the first portion from a plurality of potential transliterations of the first portion based on a statistical likelihood that a potential transliteration in the plurality of potential transliterations co-occurs in the corpus with a transliteration of the second portion preceding the first portion.

71. A system comprising:
means for receiving from a user an input of a sequence of multiple input characters entered in an input script, the sequence being terminated by entry of a word-break character, the word-break character not being part of the sequence; and
means for using a transliteration model after entry of the word-break character to determine an output word in an output script from the sequence of multiple input characters.

72. The system of claim 71, wherein the transliteration model comprises:
a plurality of segments, each segment mapping one or more characters of the input script to one or more characters of the output script.

73. The system of claim 72, wherein each segment in the plurality of segments corresponds to a word pair in a corpus of word pairs, each segment having a score based on a frequency of occurrence of the word pair in the corpus of word pairs.

74. The system of claim 73, wherein using the transliteration model comprises:
means for generating potential transliterations from the segments, each potential transliteration being derived from a combination of one or more segments; and
means for selecting the transliteration to use to determine the output word based on the scores of the segments in each of the potential transliterations.

75. The system of claim 74, further comprising:
means for pruning potential transliterations that exhibit letter and segment patterns that are statistically unlikely in reference to statistics collected from the corpus of word pairs.

76. The system of claim 71, wherein the transliteration model includes:
a dictionary having entries in the input script and, for each entry, a corresponding word in the output script.

77. The system of claim 71, wherein the word-break character is a space character or an end-of-sentence character.

78. The system of claim 71, further comprising means for replacing the sequence of multiple input characters in a user interface with the output word in the output script.

79. The system of claim 71, further comprising:
means for receiving input generated from an input device configured to generate characters in the input script.

80-101. (canceled)

102. A system comprising:
means for generating a transliteration model based on statistical information derived from a corpus of parallel text having first text in an input script and corresponding second text in an output script; and
means for using the transliteration model to transliterate a sequence of input characters in the input script to a sequence of output characters in the output script.

103. The system of claim 102, further comprising:
means for identifying multiple input words from the sequence of input characters;
means for transliterating, using the transliteration model, a first portion of the multiple input words based on one or more of:
a second portion of the multiple input words preceding the first portion, or
a third portion of the multiple input words following the first portion.

104. The system of claim 103, wherein each of the first, second and third portions correspond to a word, a phrase, or a sentence in the multiple input words.

105. The system of claim 103, further comprising:
means for selecting a transliteration of the first portion from a plurality of potential transliterations of the first portion based on a statistical likelihood that a potential transliteration in the plurality of potential transliterations co-occurs in the corpus with a transliteration of the second portion preceding the first portion.
